(19) United States
(12) Patent Application Publication
(10) Pub. No.: US 2004/0216358 A1
(43) Pub. Date: Nov. 4, 2004

(54) Wobbler

(76) Inventor: Mikael Brandt, Hangonkyla (FI)

Correspondence Address: YOUNG & THOMPSON, 745 SOUTH 23RD STREET 2ND FLOOR, ARLINGTON, VA, 22202

(21) Appl. No.: 10/820,756

(22) Filed: Apr. 9, 2004

(30) Foreign Application Priority Data
Apr. 9, 2003 (FI) U20030143

(51) Int. Cl. A01K 85/00

(52) U.S. Cl. 43/42.19; 43/42

(57) ABSTRACT

A two-part wobbler equipped with a wobbling plate and having in its front part a fixing loop for attachment of the line and a hook fixed to its rear part. The front and the rear part joined by a joint, which allows relative movement of these parts so as to give the wobbler movements resembling the swimming movements of small fish. The fixing loop is connected to a rapid fixing hook, to which a flap resembling a fish, a spinner, a butterfly or any similar additional lure can be fixed.

This invention relates to a two-part wobbler, which is equipped with a wobbling plate and comprises in its front part a fixing loop for attachment of the line and having a hook fixed to its rear part, and the front and the rear part connected by a joint, which allows relative movement of these parts so as to impart the wobbler movements resembling the swimming movements of small fish.

It has been known for decades to use wobblers in spin and draw trolling, and there are consistent efforts made to improve the fishing properties of wobblers in various ways. The fishing properties of wobblers are based on their capacity to imitate the movements of a swimming fish, and there have been myriad efforts to improve this specific property over the years.

A conventional wobler is made of a relatively well floating material, and it remains under water during pulling or winding owing to a wobbling plate located in the front part of the wobbler, the plate consisting of a flat plate protruding from the front part of the wobbler to the front and downwardly. In some solutions, the inclination of wobbling plate has even been adjustable. A conventional wobbler is stiff, and its wobbling does not fully imitate the movements of a fish even in the optimal case. This is why two-part wobblers have been made with a hinge in the centre of their body, this hinge generally allowing the wobbler body flexibility both laterally and in the up/down direction.

A second problem caused by conventional wobblers is that, due to the design and operating principle of wobblers, they usually have very poor density, and thus, especially when thrown upwind, they do not have sufficient mass to overcome air resistance. Consequently, it is arduous and in some cases even impossible to throw wobblers especially upwind. This becomes a particularly palpable problem with ultra-light fishing tackle extremely popular nowadays. Thus, for instance, when an ultra-light wobbler of 2 to 3 grams is used attached to a 0.10 mm line, downwind or calm weather is an absolute requirement.

A third problem conventionally caused by wobblers is that the undulating wobbling movement of the wobbler is generated only when the wobbler is pulled continuously, and when the pulling stops, the wobbler will either start rising directly to the surface or sink slowly, depending on the floating properties, yet the undulating progression will end anyway. In many situations, a change in the wobbling direction and speed are a key stimulus to trigger the attacking reaction of the fish, and a wobbler that has attained such properties will have appreciably better fishing potential.

FI patent specification 102502, for instance, discloses a wobbler having a design such that eliminates these drawbacks.

The purpose of this invention is to further develop the fishing properties of said wobblers.

The wobbler of the invention is characterised in having, in connection with the fixing loop, a rapid fixing hook, to which a flap resembling a fish, a spinner, a butterfly or any similar additional lure can be attached. Presumably two “fish” swimming close to each other will act as a better lure for attracting fish of prey than one single wobbler wobbling on its own.

Embodiments relating to the wobbler of the invention are described in the dependent claims.

The invention is described below with reference to the accompanying drawing, in which

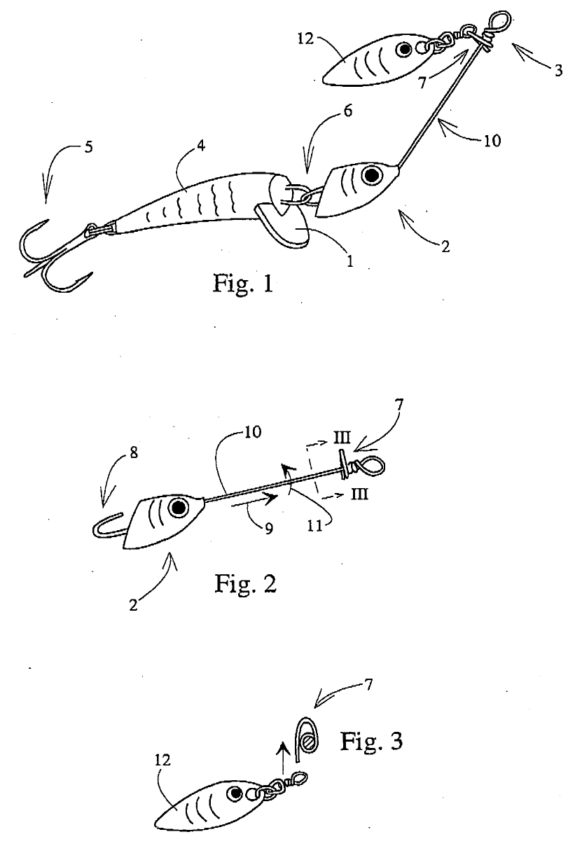

FIG. 1 shows a wobbler viewed laterally,

FIG. 2 shows the attachment of the front part of a wobbler to the fixing loop and

FIG. 3 shows a section along line III-III in FIG. 2 and the attachment of the flap to the rapid fixing hook.

The wobbler consists of a front part 2, which is a fish-shaped head made of a more dense material than the material of which wobblers are usually made. The material may be a heavy metal. The front part 2 has a fixing loop 3 for attachment of the line. A trifurcated hook 5 is fixed to the rear part 4 of the wobbler. The front and the rear part are joined by a joint 6, which allows these wobbler parts relative movements resembling the swimming movements of small fish. The fixing loop 3 is connected with a rapid fixing hook 7, to which a flap 12 resembling a fish is fixed. The loop 8 in the joint 6 of the front part 2 is hook-like and it can be retracted within the front part 2 (arrow 9) during the assembly of the wobbler so as to close the loop. Subsequently, the arm portion 10 of the fixing loop 3 is bent upwards (arrow 11), and then the loop is locked. The front part (not shown in the drawing) has a hole, which the end of the hook 8 engages.

The rapid fixing hook 7 of the flap 12 added to the wobbler consists of a thread of the fixing loop 3, which is wound around the arm portion 10 so as to form a flexible loop, which locks the flap 12 in position. When the wobbler is pulled at a suitable rate in water, the rear part of the wobbler will get a wobbling movement resembling the swimming movements of fish, and obliquely on the front/upper side a smaller flap is provided, whose movements resemble the swimming of a smaller fish and which forms a couple with the bigger “fish”.

1. A two-part wobbler equipped with a wobbling plate (1) and having in its front part (2) a fixing loop (3) for attachment of the line and a hook (5) fixed to its rear part (4), and the front and the rear part joined by a joint (6), which allows relative movement of these parts so as to give the wobbler movements resembling the swimming movements of small fish, characterised in that the fixing loop (3) is connected to a rapid fixing hook (7), to which a flap (12) resembling a fish, a spinner, a butterfly or any similar additional lure can be fixed.

2. A wobblers as defined in claim 1, characterised in that the loop (8) of the joint (6) in the front part (2) is hook-like and during the assembly of the wobblers, it can be retracted (9) into the front part so as to close the loop, and subsequently the arm portion (10) of the fixing loop (3) can be bent (11) upwardly, thus locking the loop (8).

3. A claim as defined in claim 1 characterised in that the rapid fixing hook (7) consists of a thread of the fixing loop (3), which is wound around the arm portion (10) so as to form a flexible loop, which locks the flap (12), the spinner or the butterfly in position.

4. A claim as defined in claim 2, characterised in that the rapid fixing hook (7) consists of a thread of the fixing loop (3), which is wound around the arm portion (10) so as to form a flexible loop, which locks the flap (12), the spinner or the butterfly in position.
